(19) United States
(12) Patent Application Publication
(10) Pub. No.: US 2015/0132443 A1
(43) Pub. Date: May 14, 2015

(54) PURIFICATION PROGRAM

(71) Applicant: J/J Health Solutions, LLC, Torrance, CA (US)

(72) Inventors: Nilesh Bhakta, Torrance, CA (US); Juvairiya Pulicharam, Los Angeles, CA (US)

(21) Appl. No.: 14/536,440

(22) Filed: Nov. 7, 2014

Related U.S. Application Data
(60) Provisional application No. 61/903,281, filed on Nov. 12, 2013.

(51) Int. Cl. G09B 19/00; A23L 1/29

(52) U.S. Cl. CPC G09B 19/0092; G09B 19/003; A23L 1/296; A23L 1/293; A23V 2002/00
USPC 426/87; 434/127

(57) ABSTRACT

A method for a mammal to remove toxins from the mammal's system, the method includes the steps of providing instructions for the mammal to ingest a set of substances periodically according to a set of instructions and to practice a set of wellness regimen periodically. The set of instructions comprises instructing the mammal to periodically ingest a predetermined amount of a rejuvenating substances providing the mammal with support of antioxidant activity, cytokine balance, detoxification, gastrointestinal and liver health; a predetermined amount of soluble dietary fiber substances; a predetermined amount of grasses; a predetermined amount of an antioxidant substances providing the mammal with support of antioxidant activities; predetermined amount of omega fatty acid substances and a predetermined amount of green tea. The set of wellness regimen comprises instructing the mammal to ingest a predetermined amount of water; to ingest food beverages selected from predetermined food and beverages; to exercise for a predetermined amount of time; and to manage stress.

### CROSS REFERENCE TO RELATED APPLICATIONS

This application claims the benefit of U.S. Provisional Application No. 61/903,281 filed Nov. 12, 2013, which is incorporated herein by reference in its entirety.

### FIELD OF THE INVENTION

The present invention relates to a method for a mammal to remove toxins from the mammal's system, and more particularly to a method for a mammal to remove toxins from the mammal's system by providing instructions for the mammal to ingest certain substances periodically and to practice certain wellness regimen periodically.

### BACKGROUND OF THE INVENTION

Everyday life generates unavoidable exposure to environmental toxins and human metabolic system creates unavoidable accumulation of toxins inside a mammal's body. One of the approaches towards health and wellness is to eliminate such toxins and metabolic wastes so that inflammation can be lowered and healthy bodily function can be restored.

### SUMMARY OF THE PREFERRED EMBODIMENTS

In accordance with an aspect of the present invention there is provided a method for a mammal to remove toxins from the mammal's system by providing the mammal with instructions to ingest a set of substances periodically and to practice a set of wellness regimen periodically.

In accordance with another aspect of the present invention there is provided a kit for a mammal to remove toxins from the mammal's system by providing the mammal with a set of substances and instructions to ingest aforementioned set of substances periodically and to practice a set of wellness regimen periodically.

The invention, together with additional features and advantages thereof, may be best understood by reference to the following description.

### BRIEF DESCRIPTION OF THE DRAWINGS

FIG. 1 is a flow chart diagram illustrating an exemplary embodiment of a method for a mammal to remove toxins from the mammal's system according to the present invention, involving providing instructions for the mammal to ingest a set of substances periodically and to practice a set of wellness regimens periodically; and

FIG. 2 is a flow chart diagram illustrating an aspect of another exemplary embodiment of a method for a mammal to remove toxins from the mammal's system according to the present invention, involving providing instructions for the mammal to ingest another set of substances periodically and to practice another set of wellness regimens periodically for an additional period of time.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instructions, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

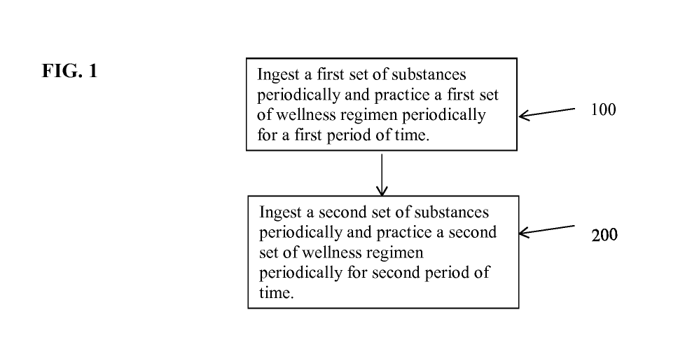

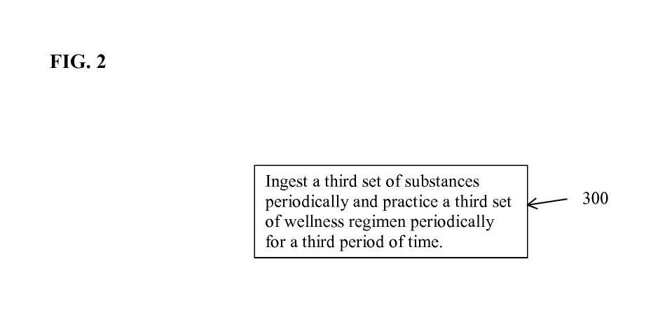

Referring now to the drawings, wherein the drawings are for purposes of illustrating the present invention and not for purposes of limiting the same, FIGS. 1-2 show a method for a mammal to remove toxins from the mammal's system. FIG. 1 shows a step 100 of a set of instructions that instructs a mammal to ingest a first set of substances periodically and to practice a first set of wellness regimen periodically, and a step 200 of the set of instructions that instructs the mammal to ingest a second set of substances periodically and to practice a second set of wellness regimen periodically. FIG. 2 shows a step 300 of a set of instructions that further instructs the mammal to ingest a third set of substances periodically and to practice a third set of wellness regimen periodically.

In a preferred embodiment, as shown in FIG. 1, the set of instructions in step 100 first instructs the mammal to ingest a first set of substances periodically. The first set of substances may include rejuvenating substances, soluble dietary fiber substances, grasses, omega fatty acid substances, antioxidant substances, and green tea.

The rejuvenating substances may include, but not limited to, substances that provide the mammal with support of antioxidant activity, cytokine balance, detoxification, gastrointestinal and liver health. In order to provide the aforementioned support for the mammal, preferably the rejuvenating substances may include protein rich in L-glutamine, glycine and taurine; ginger root, flaxseed and glutamine for gastrointestinal health; ellagic acid, watercress, green tea catechin and choline, B Vitamins, methysulfonylmethane (MSM), potassium hydrogen d-glucrate for providing detoxification support; bioflavonoids, quercetin, rutin, curcumin, N-acetyle-cysteine (NAC) and selenium glycinate providing support for antioxidant activities and cytokine balance. More preferably, the rejuvenating substances may further include multiple vitamins, minerals, folate and pantothenic acid. Optimally, the rejuvenating substances may be in the form of a powder that may be made into a shake by adding water and being blended, shaked or stirred briskly. Alternatively, the rejuvenating substances are a shake made by mixing water and from about 50 to about 60 grams of OptiCleanse™ GHI supplement powder which is manufactured by and can be obtained from XYMOGEN®.

The soluble dietary fiber substances may include, but not limited to, substances that provide a mammal cleansing and regularity support and therefore rejuvenate the mammal by cleaning waste particles inside the mammal. The soluble dietary fiber substances preferably may be psyllium, oatmeal, oat cereal, lentils, apples, oranges, pears, oat bran, strawberries, nuts, flaxseeds, beans, dried peas, blueberries, cucumbers, celery, carrots and/or the mixtures thereof. More preferably, psyllium is psyllium husk of 4-polarity psyllium. For optimal effect, the soluble dietary fiber substances may be further coupled with other substances such as marshmallow, licorice, bitter melon, black walnut, Siberian elm, pumpkin seed, cascara sagrada bark and mixtures thereof. The soluble dietary fiber substances may be in either powder or capsule form. Alternatively, the soluble dietary fiber substance is a Premier™ Cleanse dietary supplement which is manufactured by and can be obtained from Premier™ Research Lab.

The grasses may include, but not limited to, barley grass, oat grass, wheat grass and mixtures thereof. The grasses are preferably young grasses air dried at low temperature. More preferably, the grasses may further include other substances that enhance the support for health and rejuvenation. Such other substances may include, but not limited to, cholerlla, noni, blue green algae and cilantro and mixtures thereof. Preferably, chlorella is whole chlorella with broken cell walls, noni is noni fruit, blue green algae is whole algae and cilantro is cilantro leaf. Alternatively, the grasses is a Premier™ Greens dietary supplement which is manufactured by and can be obtained from Premier™ Research Lab.

The omega fatty acid substances may include substances that provide the mammal with omega fatty acids in form of both EPA and DHA. Preferably, the omega fatty acid substances may include omeg-3 fatty acids. More preferably, it may include fish oil concentrates having omega-3 fatty acids. Optimally, it may include from about 1.0 gram to about 1.4 grams of fish oil concentrate per serving. Alternatively, it is an Arctic Oils OmegaPure 900 EC™ softgel which is manufactured by and can be obtained from XYMOGEN®.

The antioxidant substances may include substances that provide the mammal with detoxification and liver support. It may include, but not limited to, ellagic acid, catechins and glucosinolates. Preferably, it may further include silymarin, artichoke leaf extract and alpha-lipoic acid. More preferably, it may further include methysulfonylmethane (MSM), B12, folate, 5-methyletrahydrofolate (5-MTHF), calcium D-glucarate and sulfate donors. Optimally, the anti-oxidant substances may include artichoke aqueous extract, watercress, milk thistle, pomegranate extract, green tea aqueous extract and mixtures thereof. Alternatively, the anti-oxidant substances is MedCaps DPO™ dual-phase optimizer which is manufactured by and can be obtained from XYMOGEN®.

The green tea is preferably to be ingested in the form of an aqueous solution. More preferably, it may be an aqueous solution of loose green tea leaves. Optimally, it may be an aqueous solution brewed or made from loose green tea leaves from Assam, India. Alternatively, the green tea is Natureal Vitality™ green tea imported from Assam, India.

In a preferred embodiment, step 100 instructs a mammal to ingest the first set of substances of a predetermined amount and at a predetermined frequency. For the rejuvenating substances, preferably, about 2 servings are to be ingested by the mammal twice per day and at least about 10 hours apart. More preferably, such 2 servings are in the form of powder can be made into a rejuvenating shake by adding water. Optimally, one serving of the rejuvenating substance may be from about 50 grams to about 60 grams of OptiCleanse™ GHI powder. Alternatively, the rejuvenating substances are to be ingested with additional food from the predetermined food and beverages list. For the soluble dietary fiber substances, preferably from about 4.5 milliliters to about 5.2 milliliters to be ingested twice per day and at least about 10 hours apart. More preferably, each time the fiber substances are to be ingested at least about 30 minutes before a meal. Optimally, from about 4.5 milliliters to about 5.2 milliliters of the fiber substances may be 1 teaspoon of Premier™ Cleanse powder including about 2 grams of psyllium. Alternatively, the soluble dietary fiber substances may be added to a rejuvenating shake or ingested separately. For the grasses, preferably from about 4.5 milliliters to about 5.2 milliliters of the grasses is to be ingested twice per day, more preferably at least about 10 hours apart. Optimally, from about 4.5 milliliters to about 5.2 milliliters of the grasses is one teaspoon of Premier™ Greens powder including about 1.9 grams of barley grass, oat grass and wheat grass. Alternatively, the grasses may be added to a rejuvenating shake or ingested separately. For the anti-oxidant substances, preferably two servings are to be ingested twice per day, more preferably, at least about 10 hours apart. Optimally, one serving of the anti-oxidant substances may include 2 capsules of MedCAPs DPO™. For the omega fatty acid substances, preferably two servings are to be ingested twice per day, more preferably at least about 10 hours apart. Optimally, one serving of the omega fatty acid substances may include from about 1.2 grams to about 1.4 grams of fish oil in form of OmegPure 900 EC™ softgel. Alternatively, the omega fatty acid substances may be taken with food from the predetermined food list. For the green tea, preferably from about 3 oz. to about 5 oz. of green tea are to be ingested twice per day, more preferably at least about 6 hours apart. Optimally, the green tea is made of Natureal Vitality™ loose leaf green tea from Assam, India. Alternatively more than from about 5 to about 10 oz. of green tea may be ingested per day.

In a preferred embodiment of the present invention, step 100 may further instruct the mammal to ingest optional lipid substances periodically. The lipid substances may include substances that provide a mammal with marine phospholipid. Preferably, it may include omega-3 phospholipid. More preferably, it may further include astaxanthin for enhanced effect. Alternatively, the lipid substances may be a LipiChol 540™ dietary supplement which is manufactured by and can be obtained from XYMOGEN®. Preferably, one serving of the lipid substances is to be ingested twice per day and at least about 10 hours apart. Optimally, one serving of the lipid substances may be one LipiChol540™ capsule including about from 500 mgs to about 600 mgs of marine phospholipids and from about 1500 to about 2500 ppms of astaxanthin.

In a preferred embodiment, step 100 further instructs a mammal to practice a first set of wellness regimen. The first set of wellness regimen may include instructing the mammal to drink a predetermined amount of water every day for the purposes of preventing constipation and preserving optimal health. Preferably, such predetermined amount is about at least 2 quarts, and more preferably, the water is filtered or spring water. Optimally, the water is to be added with freshly squeezed lemon juice from about at least half of an organic lemon.

Without restricting the amount of food to be consumed, the first set of wellness regimen further instructs the mammal to ingest only the food and beverages enlisted in a predetermined food and beverages list.

The first set of wellness regimen further instructs the mammal to exercise for the purposes of sweating to help remove toxins. Such exercises may be in any form that lasts about at least 30 minutes per day. In case the mammal cannot exercise for a continuous 30 minutes per day, the regimen instructs the mammal to break the exercise up into two 15 minutes sessions. Preferably, the exercise starts with stretching and does not have to be strenuous. Walking is an excellent form of exercising. More preferably, the exercise may be the present form of exercise the mammal is engaging, otherwise, it may requires the mammal to start slow and keep moving the body every day. Optimally, the exercise may be in some form the mammal enjoys to practice or engage in.

The first set of wellness regimen further instructs the mammal to practice stress control. Because daily stress is unlikely to be avoided, it is critical for the mammal to learn and use stress management techniques. Preferably such stress management is customized individually for the best results. More preferably, stress management techniques may include practicing yoga, meditation and prayer. Optimally, such techniques may further include utilize sound or images to help calm the mind of the mammal, as the mind, body and spirit are tightly interwined and to be truly healthy, the mammal is instructed to practice wellness regimens that address the health and wellness of all three.

In a preferred embodiment of the present invention, step 100 is preferably provided for the mammal to ingest and practice on an about 24 hour basis. More preferably step 100 is repeated about every 24 hours for a duration of about 7 days. Optimally, step 100 is repeated every 24 hours for a duration of consecutive 7 days.

In a preferred embodiment, as shown in FIG. 1, the set of instructions in step 200 instructs the mammal to ingest a second set of substances periodically. The second set of substances may include the same substances as the first set of substance does but the mammal is instructed to ingest the second set of substances of a different predetermined amount and at a different predetermined frequency. For the rejuvenating substances, preferably, one serving is to be ingested by the mammal three times per day, at least about 4 hours apart. More preferably, such 3 servings are in the form of powder can be made into a rejuvenating shake by adding water. Optimally, one serving of the rejuvenating substance may be from about 50 grams to about 60 grams of OptiCleanse™ GHI powder. Alternatively, the rejuvenating substances are to be ingested with additional food from the predetermined food and beverages list. For the soluble dietary fiber substances, preferably from about 4.5 milliliters to about 5.2 milliliters is to be ingested twice per day, at least about 10 hours apart. More preferably, each time the fiber substances are to be ingested at least about 30 minutes before a meal both in the morning and evening. Optimally, from about 4.5 milliliters to about 5.2 milliliters of the fiber substances may be 1 teaspoon of Premier™ Cleanse powder including about 2 grams of psyllium. Alternatively, the fiber substances may be added to a rejuvenating shake or ingested separately. For the grasses, preferably from about 4.5 milliliters to about 5.2 milliliters of the grasses is to be ingested twice per day, more preferably at least 4 hours apart. Optimally, 1 teaspoon of the grasses is one teaspoon of Premier™ Greens powder including about 1.9 gram of barley grass, oat grass and wheat grass. Alternatively, the grasses may be added to a rejuvenating shake or ingested separately. For the anti-oxidant substances, preferably two servings are to be ingested twice per day, more preferably, at least about 10 hours apart. Optimally, one serving of the anti-oxidant substances may include 2 capsules of MedCAPs DPO™. For the omega fatty acid substances, preferably two servings are to be ingested twice per day, more preferably at least about 10 hours apart. Optimally, one serving of the omega fatty acid substances may include from about 1.0 gram to about 1.4 grams of fish oil in form of OmegPure 900 EC™ softgel capsule. Alternatively the omega fatty acid substances may be taken with food from the predetermined food list. For the green tea, preferably from about 3 to about 5 oz. of green tea are to be ingested twice per day, more preferably at least about 6 hours apart. Optimally, the green tea is made of Natureal Vitality™ loose leaf green tea from Assam, India. Alternatively more than from about 5 to about 10 oz. of green tea may be ingested per day.

When step 100 instructs the mammal to ingest optional lipid substances periodically, step 200 may instruct the mammal to continue to ingest lipid substances. Preferably, one serving of the lipid substances is to be ingested twice per day, more preferably at least about 10 hours apart. Optimally, one serving of the lipid substances may be one LipiChol540™ softgel including about from 500 mgs to about 600 mgs of marine phospholipids and from about 1500 to about 2500 ppms of astaxanthin.

In step 200 the second wellness regimen instructs the mammal to increase the predetermined amount of water for ingestion. Preferably, the mammal is to ingest water of about half of the mammal's body weights in ounces. For example, if the mammal weighs 200 lbs, the water to be ingested may be about 100 oz. More preferably, freshly squeezed lemon juices from about at least half of an organic lemon is added to the water.

The second set of wellness regimen instructs the mammal to continue to practice the exercise and stress control related regimen from the first set of wellness regimen.

In a preferred embodiment of the present invention, step 200 is preferably provided for the mammal to ingest and practice on an about 24 hour basis. More preferably step 200 is repeated about every 24 hours for a duration of about fourteen days. Optimally, step 200 is repeated every 24 hours for a duration of consecutive fourteen days.

In a preferred embodiment, as shown in FIG. 2, the set of instructions in step 300 instructs the mammal to ingest a third set of substances periodically. The third set of substances may include maintenance substances and antioxidant substances.

The maintenance substances may include substances that provide a mammal with protein. Preferably, it may include whey protein or pea protein. More preferably, it may further include sodium, potassium, carbohydrates, cholesterol and mixtures thereof. Optimally, it may include from about 34 to about 42 percent of protein per serving. Preferably it is in the form of powder. Alternatively, the maintenance substances is FitFood™ Vegan powder or FitFood™ Whey powder which is manufactured by and can be obtained from XYMOGEN®.

For the maintenance substances, preferably one serving are to be ingested twice per day, more preferably at least about 10 hours apart. More preferably, such two servings are in the form of powder can be made into a stay fit shake by adding water, coconut water or coconut milk. Optimally, one serving of the stay fit substances may be from about 45 grams to about 55 grams of FitFood™ Whey powder, or from about 34 grams to about 40 grams of FitFood™ Vegan powder. For the omega fatty acid substances, preferably two servings are to be ingested twice per day, more preferably at least about 10 hours apart. Optimally, one serving of the omega fatty acid substances may include from about 1.0 gram to about 1.40 grams of fish oil in form of OmegPure 900 EC™ softgel capsule. Alternatively the omega fatty acid substances may be taken with food from the predetermined food list.

When step 100 and step 200 instruct the mammal to ingest optional lipid substances periodically, step 300 may instruct the mammal to continue to ingest lipid substances. Preferably, one serving of the lipid substances is to be ingested twice per day, more preferably at least about 10 hours apart. Optimally, one serving of the lipid substances may be one LipiChol540™ softgel including about from 500 mgs to about 600 mgs of marine phospholipids and from about 1500 to about 2500 ppms of astaxanthin.

In step 300 the third set of wellness regimen instructs the mammal to continue to ingest the predetermined amount of water described for step 200 so that preferably, the mammal is to ingest water of about half of the mammal's body weights in ounces. More preferably, freshly squeezed lemon juices from about at least half of an organic lemon is added to the water.

The third set of wellness regimen instructs the mammal to continue to practice the exercise and increase the amount of the exercise if possible. The third set of wellness regimen further instructs the mammal to exercise, taking sauna or hot baths in order to sweat every day. It further instructs the mammal to continue to ingest food from the allowed food and beverage list, especially continue to ingest green tea. Optionally, the mammal may start to add back food that is not on the predetermined not allowed food and beverage list after step 300.

In a preferred embodiment of the present invention, step 300 is preferably provided for the mammal to ingest and practice on an about 24 hour basis and after step 200. More preferably step 300 is repeated about every 24 hours for a duration of about 7 days. Optimally, step 300 is repeated every 24 hours for a duration of consecutive 7 days.

In a preferred embodiment of the present invention, at least one of the steps of step 100, 200 and 300 may further instruct the mammal to administer a glutathione substance periodically. The glutathione substance may provide the mammal with antioxidant activities and liver support for the purposes of removing toxins from the mammal system. Preferably, the glutathione substance may be administered during at least two of the steps of steps 100, 200 and 300. More preferably, it may be administered during all the steps of 100, 200 and 300. Optimally, the glutathione substance is a glutathione spray that is sublingually administered by the mammal so that glutathione is absorbed by the mammal more rapidly and effectively.

In a preferred embodiment of the present invention, a kit is provided to the mammal to remove toxins from the mammal's system. The kit may include a predetermined amount of a set of substances including the rejuvenating substances, soluble dietary fiber substances, grasses, omega fatty acid substances, green tea and a set of instructions that instructs the mammal to ingest the set of substances periodically and to practice a set of wellness regimen periodically, according to steps 100 and 200. The kit may further include the maintenance substances and a set of instructions according to step 300. The kit may also further include the lipid substances and the set of instructions may further instruct the mammal to ingest the lipid substances periodically, according to steps 100 and 200.

Preferably, the set of instructions of the kit instructs the mammal to ingest the set of substances periodically according to the amounts and frequencies set forth in steps 100, 200 and 300. Preferably, the amount of the set of substances provided in the kit is sufficient for the mammal to ingest according to steps 100, 200 and 300 for at least from about 3 weeks to about 4 weeks. Optimally, the kit may include about 4 jars of OptiCleanse™ GHI powder, 1 jar of the Premier™ Cleanse, 1 bottle of OmegPure 900 EC™, 1 jar of the Premier™ Greens, 2 jars of a green tea and 1 jar of FitFood™ Vegan powder or FitFood™ Whey powder. Optionally, the kit may further include 1 bottle of LipiChol540™ as an option.

In a preferred embodiment of the present invention, the kit may further include a predetermined amount of glutathione substance and the set of instructions of the kit may further instruct the mammal to administer the glutathione substance periodically.

In a preferred embodiment of the present invention, the predetermined food and beverages are to provide the mammal nutrient dense foods that will help the mammal's body heal and repair. Nourishing the mammal's body with the predetermined food and beverages may provide a complex combination of necessary nutrients to protect the mammal's body and promote health and vitality. The mammal is recommended to ingest a variety of foods and to choose different food for each day. It is further recommended that the mammal to ingest vegetables and fruits with a variety of colors and food that is fresh or frozen or organic but not canned.

The predetermined food and beverage list may include vegetables of Artichokes, Asparagus, Bamboo Shoots, Bean Sprouts, Red Beets, Bell Peppers (Red, Green and Yellow), Bok Choy, Broccoli, Brussels Sprouts, Cabbage—All Kinds, Cabbage, Cassaya, Carrots, Cauliflower, Celery, Chicory, Chives, Cucumber, Eggplant, Fennel, Garlic. Ginger Root, Green Beans, Raw Jicama, Jalapeno Peppers, Kolrabi, Leeks, Okra, Onions, Parsley, Pimentos, Pumpkin, Radishes, Radicchio, Rhubarb, Rutabagas, Sauerkraut, Shallot, Snow Peas, Snap Peas, Squash, Sweet Potatoes (preferably at least about half a sweet potato per day), Tomatoes, Turnips, Whole Chestnuts, Yams (preferably at least about half a yam Per Day), Zucchini; lettuce and greens of Arugula, Endive, Radicchio, Swiss Chard, Beet Greens, Escarole, Red/Green Leaf Lettuce, Turnip Greens, Collard Greens, Kale, Romaine Lettuce, watercress, Dandelion Greens, Mustard Greens and Spinach; fruit (limited to about 3 servings per day) of all kinds of Berries, Apples, Limes, Passion Fruit, Plums Cherries, Melons, Peaches, Pomegranates, Kiwi, Nectarines, Pears, Prunes, Lemons, Oranges, Persimmons, Tangerines, Banana, Mango, Grapes, Papaya and fresh Pineapple; grains (not wheat, Rye, Barley Or Gluten Containing) of Brown Rice, Wild Rice, Millet, Basmati Rice, Quinoa, Steel Cut Oatmeal Only, Jasmine Rice, Amaranth and Oatbran; beans and legumes of Lentils, Adzuki Beans, Mung Beans, Chick Peas (Garbanzo Beans), Bean Thread Noodles; protein of organic eggs, free range, organic and hormone free chicken and poultry; wild cold water fish (not farm raised) of Anchovies, Haddock, Perch, Trout, Butterfish, Herring, Croaker, Mackerel, Sardines, Flounder, Oysters, Pacific Sole and Salmon; fats of Organic Cold Pressed Coconut Oil and Coconut Milk, Cold Pressed Extra Virgin Olive Oil, Flaxseed (Whole and Grind Fresh without being heated), coconut oil, hemp oil, Raw Nuts (No Peanuts) of Almonds, Walnuts and Pistachio, seeds of Pumpkin Seeds, Chia Seeds and Sunflower Seeds; beverages of filter or spring water, lemon water, green tea, herbal tea, unsweetened vegetable juice and green vegetable juice; and condiments of Sea Salt, Himalayian Sea Salt, organic Spices and Herbs, Braggs Raw Apple Cider Vinegar.

In a preferred embodiment of the present invention, the predetermined Food and beverages not for a mammal preferably to ingest include: Sports Drinks, Energy Drinks, Sodas or Diet Drinks, Tap Water; Dairy Products or Anything Made with; Grains Except those Listed on Allowed Food List; Flour Products—Cookies, Cakes, Crackers, Muffins, Bread; Sugar, Artificial Sweetners other than Stevia & Xylitol are Allowed; Morton Table Salt—Sea Salt or Pink Himalayan Salt is Allowed; Packaged or Processed Food—If in Doubt Don't Eat it Until You Ask; Refined Oil—Vegetable Oil, Corn Oil, Canola Oil, Margarine, Soybean Oil; Red Meat Until After step 300; Pork; Fruit Juice; Foods Containing Yeast or Any Food that Promotes Yeast Overgrowth Such as Processed Packaged Foods, Sugar, Commercially Bottled Condiments, Breads, Peanuts, Vinegar, Foods Containing Wheat, Rye, Bailey, Soy or Corn; Grapefruit or Grapefruit Juice, heated flaxseeds, radiated spices and herbs; farmed raise fish, Blue Fish, Tuna, Shark, Grouper, Marlin, Swordfish, Sea Bass, Orange Roughy, Tilefish; peanuts; fruit juice, ketchup, Mayonaise, Soy Sauce, Worcestershire Sauce, BBQ Sauce, Packaged or Bottled Dressings, Relish and Seasoning.

In a preferred embodiment of the present invention, the set of instructions may further comprise a set of general guidelines to enhance and supplement the efficacy of the purification method to remove toxins. The set of general guidelines includes, but not limited to the following activities:
For a mammal ingesting lots of simple sugars, carbohydrates, alcohol, tobacco, decaffeinated coffee or caffeinated beverages, the mammal may practice gradually tapering off on ingesting these aforementioned substances at least about 7 days before starting step 100.
A mammal may ingest at least about 64 oz. of filtered or spring water per day. It is recommended the mammal ingest water of a temperature between about 160 to about 175° F. The mammal may add to the water freshly squeezed lemon juice from preferably about half of an organic fresh lemon and try to ingest up to half of the mammal's body weight in ounces. For example, if the mammal weighs 100 lbs. the mammal may drink at least about 50 ounces of water per day.
When starting the program, the mammal may have the rejuvenating substances made into a shake the night before and then start the first day with one at breakfast and one at dinner. The mammal may continue this for the first week and then practice having 1 shake at breakfast, 1 at lunch and 1 a dinner for weeks 2-3.
To lose weight, the mammal may drink the shake 1 hour before a meal and decrease the amount of food to be ingested.
To help curb cravings, the mammal may have a glass of water with fresh squeezed lemon or lime, add a sliced cucumbers or strawberries, take a walk or engage in activities that would take the mammal's mind off food. The mammal may ingest Gymnema herb that is also helpful to curb cravings.
The mammal may want to cook in a specific manner, e.g, steam or lightly stir fry vegetables in filtered water or vegetable broth at low heat, use coconut oil, not to boil vegetables, oven roast vegetables with coconut oil or olive oil, use a variety of spices for flavor, use pink Himalyan seal salt not Morton™ table salt, try to ingest at least ½ to ¾ of the vegetables raw.
The mammal may try to buy organic food as much as possible, to avoid ingesting the toxic chemicals from herbasides, pesticides and chemical fertilizers used with conventionally grown fruits and vegetables, to ingest a wide variety of the food.
The mammal may avoid packaged salad dressing, to ingest home made dressings such as cold pressed extra-virgin olive oil and Braggs Raw Apple Cider Vinegar.
The mammal may avoid heavy, hard to digest proteins, to choose organic free range poultry and eggs from free range, hormone free chicken, to ingest wild caught cold water fish, to avoid farm raised fish and local lake fish.
The mammal may ingest frequently throughout the day, and to ingest as much as the mammal wants from the predetermined foods list, not to skip meals, to try to ingest every 4 to 5 hours and try to ingest a lot of vegetables.
The mammal may try to get about 7-9 hours of sleep per day during the program, try to spend more time relaxing.
The mammal may try to exercise so the mammal sweats without overdoing it. If the mammal has not been exercising for a while, the mammal may start slowly. Good examples are walking about 30 minutes or more every day, taking deep breaths, engaging strength training, jumping on a mini-rampoline like device for about 5 minutes or more at a time.
The mammal may try to control stress so that the mammal may better digest food, heal and repair. The mammal may try to find time to relax with methods best suitable for the mammal, e.g., to ingest clean water and healthy nutrient rich foods, to practice meditation, yoga, prayer, taking a relaxing warm bath.

In a preferred embodiment of the present invention, the set of instructions may further comprise a set of useful tips. The set of useful tips may include, but not limited to the following activities:
If going out of town, the mammal may pack a shaker cup, small ziplock bags for packing 2 servings of the powder, pack as much as it needs until returning home; buy bottled water or coconut water to make shakes with the powder. If the mammal is ingesting a meal, try to ingest a shake before the meal to reduce temptation of over-ordering. The mammal may choose roasted, baked or broiled protein, ask for steamed vegetables, add a little butter on special occasions, ask how the food is prepared and ask to restaurants to cook food the way request.
The mammal may drink about 1 cup of hot water with freshly squeezed lemon and a pinch or two of cayenne pepper as the first beverage in the morning on an empty stomach.
The mammal may use a dry, soft skin brush to gently exfoliate the mammal's skin before getting into a shower.
The mammal may ingest clean water and not tap water, put a filter to the mammal's shower,
The mammal may take a warm bath with Epsom Salt, or a few drops of lavender or other essential oils added.
The mammal may avoid plastics such as plastic containers whenever possible, not heat food in plastic containers, avoid storing acidic foods in plastic containers.
The mammal may try alternating the temperature of a shower from hot to cold, rub the mammal's body With Epsom salt and a warm wet washcloth.
The mammal may try to take steam sauna.
The mammal may avoid microwaving food, try to heat food on a stovetop or oven whenever possible, try to avoid Teflon and synthetic non-stick coatings on cookware.
The mammal may try to buy organic food whenever possible. If organic food varieties are not available, the mammal may try to ingest produce that consistently have the lowest level of pesticides and are therefore safer choices. Such food may include: bananas, kiwi, mangos, papaya, pineapple, avocado, asparagus, broccoli and cauliflower.
The mammal may snack on fruits and vegetables throughout the day, add a little protein in form of nuts and seeds.
The mammal may try to ingest about 1½-2 cups of an alkaline broth made from a combination of the following vegetables: celery, zucchini, spinach, parsley, kale and cilantro.
The mammal may avoid environmental toxins as much as possible, e.g., avoid food additives and preservatives, buy organic produce and. organic, free range, hormone free meat and poultry, buy only wild caught seafood instead of farm raised food, use natural organic cleaning products, personal care products and make-up, ingest only filtered water, avoid plastic and non-stick cookware, use natural pest control products and avoid second hand smoke, avoid canned food and drinks, avoid artificial sweeteners, avoid fried foods, avoid GMO (genetically modified organisms) such as corn, soy, canola, cotton, Hawaiian papaya, zucchini and yellow squash, wheat and other sources of GMO including dairy products from cows injected with RbGH, food additives, food flavoring, processing agents including the sweetener aspartame and rennet, used to make head cheese, meat, eggs and dairy products from animals that have ingested GMO feed, honey and bee pollen that may have GMO sources of pollen, use information available on websites to avoid GMO food.
The mammal may avoid temptation to ingest foods that are damaging to health and well-being. Such foods are processed, refined, fried, high in the bad fats, bad refined salts and sugar, contain chemicals and artificial ingredients, try ingest Gymnema herb to help curbing the cravings.
The mammal may try to enjoy the process of removing the toxins, to expect to experience ups and downs, both physically and mentally; to keep a journal recording what and how the mammal ingest food, to be specific of food items and ingredients, to record how the mammal feels, what physical effects the mammal is experiencing such as headaches, constipation or loose bowels, gas, boating, any skin reactions, etc., to keep a record of any other parallel purification techniques the mammal is practicing such as massage, saunas, hot baths, etc., to keep track of exercise and to record the amount of water ingested.
The mammal may ingest a good amount of fiber and a lot of purified water, to take at least about 10 deep breaths, to practice dry skin brushing, sweating and using natural organic skin products.
The mammal may avoid to build-up hurtful emotions, thoughts, memories.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A method for a mammal to remove toxins from the mammal's system, the method comprising the steps of:
providing instructions for the mammal to ingest a set of substances periodically according to a set of instructions and to practice a set of wellness regimen periodically,
wherein the set of instructions comprises instructing the mammal to periodically ingest a predetermined amount of a rejuvenating substances providing the mammal with support of antioxidant activity, cytokine balance, detoxification, gastrointestinal and liver health; a predetermined amount of soluble dietary fiber substances; a predetermined amount of grasses; a predetermined amount of an antioxidant substances providing the mammal with support of antioxidant activities; predetermined amount of omega fatty acid substances and a predetermined amount of green tea, and
wherein the set of wellness regimen comprises instructing the mammal to ingest a predetermined amount of water; to ingest food beverages selected from predetermined food and beverages; to exercise for a predetermined amount of time; and to manage stress.

2. The method of claim 1 further comprising providing instructions for the mammal according to the set of the instructions for a first consecutive and a second consecutive period of time, wherein the set of instructions comprises instructing the mammal to ingest a different amount of rejuvenating substance during the second consecutive period of time.

3. The method of claim 2 further comprising providing instructions for the mammal according to a set of maintenance instructions and to practice a maintenance wellness regimen periodically for a third consecutive period of time, wherein the set of maintenance instructions comprises instructing the mammal to ingest periodically a predetermined amount of maintenance substances providing the mammal with support of gastrointestinal health, sport nutrition and weight management; a predetermined amount of omega fatty acid substances, wherein the maintenance wellness regimen comprises instructing the mammal to ingest a predetermined amount of water, food and beverages selected from the predetermined food and beverages; and to exercise, sweat, take sauna and/or a hot bath.

4. The method of claim 1, wherein the set of instructions further comprises instructing the mammal to periodically ingest a predetermined amount of lipid substances.

5. The method of claim 3, wherein the set of instructions further comprises instructing the mammal to periodically ingest a predetermined amount of lipid substances, and wherein the set of maintenance instructions further comprises instructing the mammal to ingest periodically a predetermined amount of lipid substances.

6. The method of claim 1, wherein the mammal periodically ingesting the rejuvenating substances, soluble dietary fiber substances, grasses, antioxidant substance and omega fatty acid substances is twice per 24 hours, wherein the ingesting is at least about 6 hours apart.

7. The method of claim 6, wherein the mammal ingesting the soluble dietary fiber substances is at least about 30 minutes before a meal.

8. The method of claim 6, wherein the mammal ingesting the soluble dietary fiber substances is with ingesting the rejuvenating substances.

9. The method of claim 6, wherein the mammal ingesting the grasses is with ingesting the rejuvenating substances.

10. The method of claim 6, wherein the mammal ingesting the antioxidant substances is with ingesting the rejuvenating substances.

11. The method of claim 1, wherein the mammal ingesting the green tea is once per 24 hours.

12. The method of claim 11, wherein the mammal ingesting the green tea is twice per 24 hours, wherein the ingesting is at least about 3 hours apart.

13. The method of claim 4, wherein the mammal ingesting the lipid substances is twice per 24 hours, wherein the ingesting is at least about 6 hours apart.

14. The method of claim 2, wherein the mammal ingesting the rejuvenating substances is three times per 24 hours, wherein the ingesting is at least about 3 hours apart.

15. The method of claim 3, wherein the mammal ingesting the maintenance substance and the omega fatty acid substances is twice per 24 hours, wherein the ingesting is at least about 6 hours apart.

16. The method of claim 5, wherein the mammal ingesting the lipid substances is twice per 24 hours, wherein the ingesting is at least about 6 hours apart.

17. The method of claim 1, wherein the rejuvenating substances comprise protein, ginger root, ellagic acid, B Vitamins, potassium hydrogen d-glucarate and bioflavonoids.

18. The method of claim 17, wherein the rejuvenating substance further comprise protein rich in L-glutamine, glycine and taurine, flaxseed, glutamine, watercress, green tea catechin, choline, methysulfonylmethane (MSM), quercetin, rutin, curcumin, N-acetyle-cysteine (NAC) and selenium glycinate.

19. The method of claim 1, wherein the soluble dietary fiber substances are selected from the group consisting of psyllium and soluble fibers from oatmeal, oat cereal, lentils, apples, oranges, pears, oat bran, strawberries, nuts, flaxseeds, beans, dried peas, blueberries, cucumbers, celery, carrots and mixtures thereof.

20. The method of claim 19, wherein the psyllium is 4-polarity psyllium.

21. The method of claim 20, wherein the psyllium is preferably at least about from 1500 mg to 2050 mg.

22. The method of claim 19, wherein the soluble fiber further substances comprise marshmallow, licorice, bitter melon, black walnut, Siberian elm, pumpkin seed, cascara sagrada bark and mixtures thereof.

23. The method of claim 1, wherein the grasses comprise barley grass, oat grass and wheat grass.

24. The method of claim 23, wherein the grasses further comprise substances comprising chlorella, noni, blue green algae and cilantro.

25. The method of claim 1, wherein the antioxidant substances comprise ellagic acid, catechins and glucosinolates.

26. The method of claim 25, wherein the antioxidant substances further comprises silymarin, artichoke leaf extract and alpha-lipoic acid, methysulfonylmethane (MSM), B12, folate, 5-methyletrahydrofolate (5-MTHF), calcium D-glucarate and sulfate donors.

27. The method of claim 1, wherein the omega fatty acid substances comprise omega fatty acids in form of both EPA and DHA.

28. The method of claim 27, wherein the omega fatty acids comprise fish oil having omega-3 fatty acids.

29. The method of claim 27, wherein the omega fatty acid substances preferably comprise at least about from 1.0 gram to about 1.4 grams of fish oil per serving.

30. The method of claim 1, wherein the green tea is an aqueous solution of loose leaf green tea.

31. The method of claim 30, wherein the loose leaf green tea preferably is from Assam, India.

32. The method of claim 1, wherein the maintenance substances comprise
whey protein or pea protein.

33. The method of claim 32, wherein the maintenance substances further comprise sodium, potassium, carbohydrates, cholesterol and mixtures thereof.

34. The method of claim 4, wherein the lipid substances comprise marine phospholipid.

35. The method of claim 34, wherein the lipid substances further comprise astaxanthin.

36. The method of claim 1, wherein the water is selected from the group consisting of filtered water, spring water and mixtures thereof.

37. The method of claim 36, wherein the water further comprises freshly squeezed lemon juice from at least half of a lemon.

38. The method of claim 1, wherein the predetermined food are selected from a group of food and beverages.

39. The method of claim 1, wherein the predetermined beverages are selected from a group of food and beverages.

40. The method of claim 1, wherein to exercise comprises walking, any form of exercises that make the mammal sweat, or any form of exercises that are suitable for the mammal.

41. The method of claim 2, wherein to manage stress comprises practicing yoga, meditation, prayer, listening to music and sound.

42. The method claim 1 wherein the set of instructions further comprises instructing the mammal to taper off ingesting substance selected from the group consisting of alcohol, caffeine, tobacco, decaffeinated coffee and mixtures thereof for a predetermined period of time prior to a start of ingesting the set of substances.

43. The method of claim 3, wherein the mammal ingesting food periodically comprises ingesting food and beverages that are not on a predetermined not allowed food and beverages.

44. The method of claim 1 wherein the set of instructions further comprises instructing the mammal to practice at least one activity selected from a set of general guideline.

45. The method of claim 1 wherein the set of instructions further comprises instructing the mammal to practice at least one activity selected from a set of easy tips.

46. A kit for a mammal to remove toxins from the mammal's system, the kit comprising:
a set of substances and a set of instructions, wherein:
the set of substances comprise a predetermined amount of rejuvenating substances, a predetermined amount of soluble dietary fiber substances, a predetermined amount of grasses, a predetermined amount of omega fatty acid substances, a predetermined amount of antioxidant substances, a predetermined amount of green tea and a predetermined amount of maintenance substances; and
the set of instructions comprises instructing the mammal to ingest the set of substances periodically according to a set of ingesting instructions and to practice a set of wellness regimen periodically,
wherein the set of ingesting instructions comprises instructing the mammal to periodically ingest a predetermined amount of a rejuvenating substances providing the mammal with support of antioxidant activity, cytokine balance, detoxification, gastrointestinal and liver health; a predetermined amount of soluble dietary fiber substances; a predetermined amount of grasses; a predetermined amount of an antioxidant substances providing the mammal with support of antioxidant activities; predetermined amount of omega fatty acid substances and a predetermined amount of green tea, and
wherein the set of wellness regimen comprises instructing the mammal to ingest a predetermined amount of water; to ingest food beverages selected from predetermined food and beverages; to exercise for a predetermined amount of time; and to manage stress.

47. The kit of claim 46, wherein the set of substances further comprises a maintenance substances and the set of ingesting instructions further comprises instructing the mammal to ingest the maintenance substances periodically.

48. The kit of claim 46 further comprising a predetermined amount of lipid substances, wherein the set of instructions further comprises instructing the mammal to periodically ingest the lipid substances.

49. The kit of claim 47, wherein the set of substances further comprise a predetermined amount of lipid substances, wherein the set of instructions further comprises instructing the mammal to periodically ingest the lipid substances.

50. The method of claim 1, wherein the set of substances further comprises a glutathione spray, and the set of instructions further comprises instructing the mammal to administer the glutathione spray periodically.

51. The kit of claim 46, wherein the set of substances further comprises a glutathione spray, and the set of ingesting instructions further comprises instructing the mammal to administer the glutathione spray periodically.
